(19) United States
(12) Patent Application Publication
(10) Pub. No.: US 2021/0095717 A1
(43) Pub. Date: Apr. 1, 2021

(54) ROLLING STRUCTURE AND METHOD OF MOUNTING THE SAME ON OBJECT

(71) Applicant: FIVETECH TECHNOLOGY INC., New Taipei City (TW)

(72) Inventors: TING-JUI WANG, New Taipei City (TW); WEI-CHEN HUANG, New Taipei City (TW)

(21) Appl. No.: 17/024,735

(22) Filed: Sep. 18, 2020

(30) Foreign Application Priority Data
Sep. 26, 2019 (TW) 108134962

(51) Int. Cl. F16C 29/04

(52) U.S. Cl. CPC F16C 29/04

(57) ABSTRACT

A rolling structure and a method of mounting the same on an object are introduced. The rolling structure includes a body portion, a first rolling member and at least one second rolling member. The body portion is disposed at an object. The first rolling member is movably disposed at the body portion and adapted to roll in the first direction. The second rolling member is movably disposed at the body portion and adapted to roll in the second direction. Therefore, the rolling structure is structurally simple, easy to use, and mechanically strong so as to cut cost.

### CROSS-REFERENCE TO RELATED APPLICATION

This non-provisional application claims priority under 35 U.S.C. § 119(a) on Patent Application No(s). 108134962 filed in Taiwan, R.O.C. on Sep. 26, 2019, the entire contents of which are hereby incorporated by reference.

### BACKGROUND OF THE INVENTION

### 1. Field of the Invention

The present disclosure relates to rolling structures and methods of mounting the same on an object and, more particularly, to a rolling structure and a method of mounting the same on an object, thereby allowing the rolling structure to be structurally simple, easy to use, and mechanically strong so as to cut cost.

### 2. Description of the Related Art

To reduce the friction between the rails or other objects, a moving object (for example, frame or movable doors of cabinets, drawers, movable shelves, etc.) usually chooses to install a number of wheels. A wheel is in contact with the track or other objects through the rolling wheel, so the friction caused by the movement of the two objects can be reduced, and the moving object can move more smoothly.

However, the conventional wheels can be used for rolling, they have some disadvantages of complex wheel structure, weaker strength and higher cost.

Therefore, it is imperative to provide a rolling structure and a method of mounting the same on an object, thereby allowing the rolling structure to be structurally simple, easy to use, and mechanically strong so as to cut cost.

### BRIEF SUMMARY OF THE INVENTION

In view of the aforesaid drawbacks of the prior art, the inventor of the present disclosure conceived room for improvement in the prior art and thus conducted extensive researches and experiments according to the inventor's years of experience in the related industry, and finally developed a rolling structure and a method of mounting the same on an object as disclosed in the present disclosure, thereby allowing the rolling structure to be structurally simple, easy to use, and mechanically strong so as to cut cost.

In order to achieve the above and other objectives, the present disclosure provides a rolling structure comprising: a body portion, a first rolling member and at least one second rolling member. The body portion is disposed at an object. The first rolling member is movably disposed at the body portion and adapted to roll in the first direction. The second rolling member is movably disposed at the body portion and adapted to roll in the second direction.

The present disclosure further provides a rolling structure comprising: a body portion and at least one first rolling member. The body portion has a first fitting portion, and the first fitting portion is fitted to an object. The first rolling member is movably disposed at the body portion and adapted to roll in the first direction.

In an embodiment of the rolling structure, the body portion has a first stopping portion and a second stopping portion between which the first rolling member is disposed.

In an embodiment of the rolling structure, the body portion has a receiving portion for receiving the second rolling member.

In an embodiment of the rolling structure, the second rolling member is connected by a joint portion with the body portion fitting.

In an embodiment of the rolling structure, the body portion has a receiving portion, and an edge of the receiving portion has a blocking portion, allowing the second rolling member to be blocked by the blocking portion and thus disposed in the receiving portion.

In an embodiment of the rolling structure, the second rolling member and rolling members match and roll to thereby reduce rolling friction of the second rolling member, and the rolling members each have a smaller volume than the second rolling member.

In an embodiment of the rolling structure, the first rolling member and the second rolling member roll on corresponding members of different directions simultaneously.

In an embodiment of the rolling structure, the body portion has an axle portion, and the first rolling member is fitted to the axle portion.

In an embodiment of the rolling structure, the axle portion has a second fitting portion, and the second fitting portion is a through hole, intercepting portion, slot portion, raised portion or dented portion.

In an embodiment of the rolling structure, the body portion is movably fitted to the first fitting portion, such that the body portion rotates or moves at the first fitting portion.

In an embodiment of the rolling structure, the first fitting portion has a receiving portion for receiving the body portion.

In an embodiment of the rolling structure, the first rolling member or the second rolling member is connected by a joint portion with the body portion, and the joint portion is a post member, engaging member, bolt member, raised member or dented member.

In an embodiment of the rolling structure, rolling members are disposed between the first fitting portion and the body portion and adapted to reduce friction between the first fitting portion and the body portion.

In an embodiment of the rolling structure, the first fitting portion has a feeding portion which a material of the object flows into or enters when the first fitting portion is pressed against the object, such that the first fitting portion is fitted to the object.

In an embodiment of the rolling structure, the first fitting portion has an expandably connecting portion, and the expandably connecting portion is pressed under an applied force, thereby allowing the expandably connecting portion to be expandably connected to the object.

In an embodiment of the rolling structure, the first fitting portion has a weldable surface, the weldable surface is heated for welding to the object.

In an embodiment of the rolling structure, the rolling structure is used to compare the position of the rolling structure with the object through a comparison device after being picked up by a tool, and the rolling structure is placed on the object with the tool for assembly.

In an embodiment of the rolling structure, the carrying member has a cover member, and the tool is a vacuum sucker, clamp implement, magnetic tool or engaging implement.

In an embodiment of the rolling structure, the body portion is movably fitted to a limiting portion through a body member portion.

In an embodiment of the rolling structure, the body member portion has a blocking portion, such that the blocking portion blocks the limiting portion and rotates relative thereto.

In an embodiment of the rolling structure, the body portion is movably fitted to a limiting portion through a body member portion, and the second rolling member is disposed at the body member portion and rotates.

In an embodiment of the rolling structure, the second rolling member is disposed at the body member portion and rotates, and the first rolling member is confined to between the body portion and the second rolling member.

In an embodiment of the rolling structure, the direction in which the first rolling member rolls and the direction in which the second rolling member rolls are perpendicular to each other.

In an embodiment of the rolling structure, the first rolling member and the second rolling member are in contact with each other while rolling.

In an embodiment of the rolling structure, the first rolling member has a receiving space for receiving part of the second rolling member.

In an embodiment of the rolling structure, the rolling structure and a carried member together form a rolling module structure.

In an embodiment of the rolling structure, the object is a server, storage, cabinet, casing member, drawer, rail, PCB, motherboard, object, rod member, block member, rack member, carrying member or carried member.

The present disclosure further provides a method of mounting a rolling structure on an object, the rolling structure having a body portion, a first rolling member and at least one second rolling member, the first rolling member being movably disposed at the body portion and adapted to roll in the first direction, the second rolling member being movably disposed at the body portion and adapted to roll in the second direction, or the rolling structure having a body portion and at least one first rolling member, the first rolling member being movably disposed at the body portion and adapted to roll in the first direction, the method comprising the steps of: providing a tool for taking out the rolling structure; providing a comparison device for comparing the assembly position of the rolling structure and the object; using the tool to move the rolling structure to a predetermined height on the assembly position of the object according to the comparison information of the comparison device; and let the tool release or loosen the rolling structure, so that the rolling structure falls to the assembly position of the object.

Therefore, the rolling structure of the present disclosure is structurally simple, easy to use, and mechanically strong so as to cut cost.

### BRIEF DESCRIPTION OF THE DRAWINGS

FIG. 1 is a schematic view of how to operate a rolling structure according to the first embodiment of the present disclosure.

FIG. 2 is a schematic view of how to operate the rolling structure according to the second embodiment of the present disclosure.

FIG. 3 is a schematic view of how to operate the rolling structure according to the third embodiment of the present disclosure.

FIG. 4 is a schematic view of how to operate the rolling structure according to the fourth embodiment of the present disclosure.

FIG. 5 is a cross-sectional view of the rolling structure according to the fifth embodiment of the present disclosure.

FIG. 6 is a perspective view of the rolling structure according to the sixth embodiment of the present disclosure.

FIG. 7 is a cross-sectional view of the rolling structure according to the seventh embodiment of the present disclosure.

FIG. 8 is a cross-sectional view of the rolling structure according to the eighth embodiment of the present disclosure.

FIG. 9 is a cross-sectional view of how to mount the rolling structure in place according to the ninth embodiment of the present disclosure.

FIG. 10 is a cross-sectional view of how to mount the rolling structure in place according to the tenth embodiment of the present disclosure.

FIG. 11 is a cross-sectional view of how to mount the rolling structure in place according to the eleventh embodiment of the present disclosure.

FIG. 12 is a cross-sectional view of the rolling structure according to the twelfth embodiment of the present disclosure.

FIG. 13 is a perspective view of the rolling structure according to the twelfth embodiment of the present disclosure.

FIG. 14 is a cross-sectional view of the rolling structure according to the thirteenth embodiment of the present disclosure.

### DETAILED DESCRIPTION OF THE INVENTION

To facilitate understanding of the object, characteristics and effects of this present disclosure, embodiments together with the attached drawings for the detailed description of the present disclosure are provided.

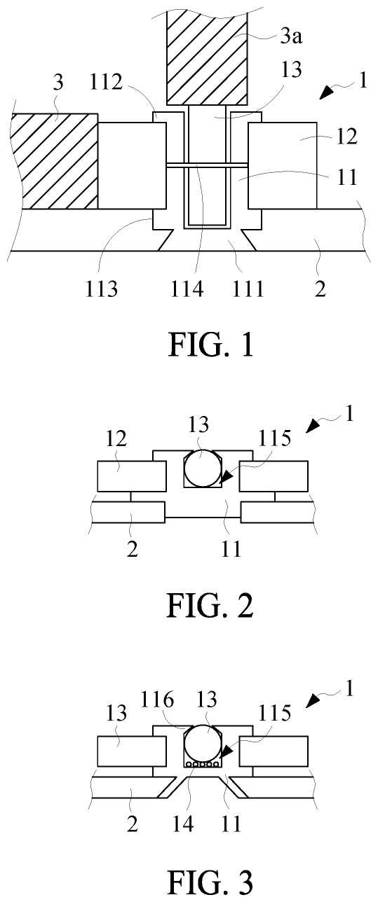

Referring to FIG. 1, the present disclosure provides a rolling structure 1. The rolling structure 1 comprises a body portion 11, a first rolling member 12 and at least one second rolling member 13.

The body portion 11 has a first fitting portion 111. The first fitting portion 111 is fitted to an object 2. The object 2 is a server, storage, cabinet, casing member, drawer, rail, PCB, motherboard, object, rod member, block member, rack member, carrying member or carried member.

The first rolling member 12 is movably disposed at the body portion 11. The first rolling member 12 rolls in the first direction.

The second rolling member 13 is movably disposed at the body portion 11. The second rolling member 13 rolls in the second direction.

To use the rolling structure 1, a user fits the rolling structure 1 to the object 2, such that the first rolling member 12 rolls in the first direction, and the second rolling member 13 rolls in the second direction, allowing the first rolling member 12 and the second rolling member 13 to roll on corresponding members 3, 3a of different directions simultaneously. Therefore, the rolling structure 1 is structurally simple, easy to use, and mechanically strong to cut cost.

In a preferred embodiment of the present disclosure, the body portion 11 has a first stopping portion 112 and a second stopping portion 113. The first rolling member 12 is disposed between the first stopping portion 112 and the second stopping portion 113. Therefore, the first rolling member 12 is confined to between the first stopping portion 112 and the second stopping portion 113 and thus firmly coupled to the body portion 11, thereby augmenting the structural strength of the rolling structure 1.

In a preferred embodiment of the present disclosure, the second rolling member 13 is connected by a joint portion 114 with the body portion 11 fitting. The joint portion 114 is a post member, engaging member, bolt member, raised member or dented member. Therefore, owing to the limitative function of the joint portion 114, the second rolling member 13 is firmly coupled to the body portion 11, so as to augment the structural strength of the rolling structure 1.

The rolling structure 1 and a carried member together form a rolling module structure (not shown), thereby allowing the present disclosure to meet practical usage needs.

Referring to FIG. 2, in a preferred embodiment of the present disclosure, the body portion 11 has a receiving portion 115 for receiving the second rolling member 13. Therefore, the rolling structure 1 is fitted to the object 2, such that the first rolling member 12 rolls in the first direction, and the second rolling member 13 rolls in the second direction, thereby allowing the first rolling member 12 and the second rolling member 13 to roll on corresponding members (not shown) of different directions simultaneously. Therefore, the rolling structure 1 is structurally simple, easy to use, and mechanically strong so as to cut cost.

Referring to FIG. 3, in a preferred embodiment of the present disclosure, the body portion 11 has a receiving portion 115, and the edge of the receiving portion 115 has a blocking portion 116. The second rolling member 13 is blocked by the blocking portion 116 and thus disposed in the receiving portion 115. The second rolling member 13 and rolling members 14 received in the receiving portion 115 match and roll to thereby reduce the rolling friction of the second rolling member 13. The rolling members 14 each have a smaller volume than the second rolling member 13. Therefore, the rolling structure 1 is fitted to the object 2, such that the first rolling member 12 rolls in the first direction, and the second rolling member 13 matches the rolling members 14 to thereby roll in the second direction, thereby allowing the first rolling member 12 and the second rolling member 13 to roll on corresponding members (not shown) of different directions simultaneously. Therefore, the rolling structure 1 is structurally simple, easy to use, and mechanically strong so as to cut cost.

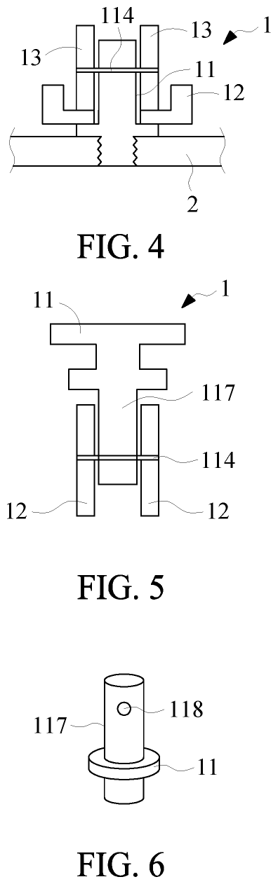

Referring to FIG. 4, in a preferred embodiment of the present disclosure, two second rolling members 13 are provided, and the second rolling members 13 are connected by the joint portion 114 with the body portion 11 fitting, such that the second rolling members 13 are firmly coupled to the body portion 11, so as to augment the structural strength of the rolling structure 1. Therefore, the rolling structure 1 is fitted to the object 2, such that the first rolling member 12 rolls in the first direction, and the second rolling member 13 rolls in the second direction, thereby allowing the first rolling member 12 and the second rolling members 13 to roll on corresponding members (not shown) of different directions simultaneously. Therefore, the rolling structure 1 is structurally simple, easy to use, and mechanically strong so as to cut cost.

Referring to FIG. 5, in a preferred embodiment of the present disclosure, the body portion 11 has an axle portion 117, the first rolling member 12 is set on the axle portion 117, In this embodiment, the first rolling members 12 are in the number of two, and the first rolling members 12 are disposed on two sides of the axle portion 117, respectively, and the first rolling members 12 are connected by the joint portion 114 with the body portion 11. Therefore, the rolling structure 1 can be fitted to the object (not shown), such that the first rolling members 12 roll in the first direction, thereby allowing the rolling structure 1 to be structurally simple, easy to use, and mechanically strong so as to cut cost.

Referring to FIG. 6, in a preferred embodiment of the present disclosure, the axle portion 117 has a second fitting portion 118. The second fitting portion 118 is a through hole, intercepting portion, slot portion, raised portion or dented portion, such that the first rolling member 12 can extend the axle portion 117 from the second fitting portion 118, thereby allowing the present disclosure to meet practical usage needs.

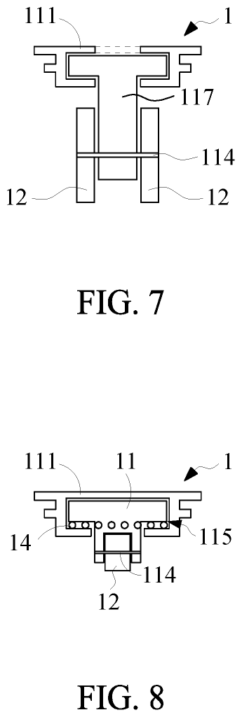

Referring to FIG. 7, in a preferred embodiment of the present disclosure, the first rolling members 12 are in the number of two. The first rolling members 12 are fitted to the two sides of the axle portion 117, respectively. The first rolling members 12 are connected by the joint portion 114 with the body portion 11, and the body portion 11 is movably fitted to the first fitting portion 111, such that the body portion 11 rotates or moves at the first fitting portion 111. Therefore, the rolling structure 1 can be fitted to the object (not shown), such that the first rolling members 12 roll in the first direction, whereas the body portion 11 rotates or moves in the second direction within the first fitting portion 111. Therefore, the rolling structure 1 is structurally simple, easy to use, and mechanically strong so as to cut cost.

Referring to FIG. 8, in a preferred embodiment of the present disclosure, the first fitting portion 111 has a receiving portion 115 for receiving the body portion 11, and rolling members 14 are disposed between the first fitting portion 111 and the body portion 11. The rolling members 14 reduce the friction between the first fitting portion 111 and the body portion 11, such that the body portion 11 can rotate or move easily. Therefore, the rolling structure 1 can be fitted to the object (not shown), such that the first rolling member 12 rolls in the first direction, whereas the body portion 11 rotates or moves in the second direction within the first fitting portion 111. Therefore, the rolling structure 1 is structurally simple, easy to use, and mechanically strong so as to cut cost.

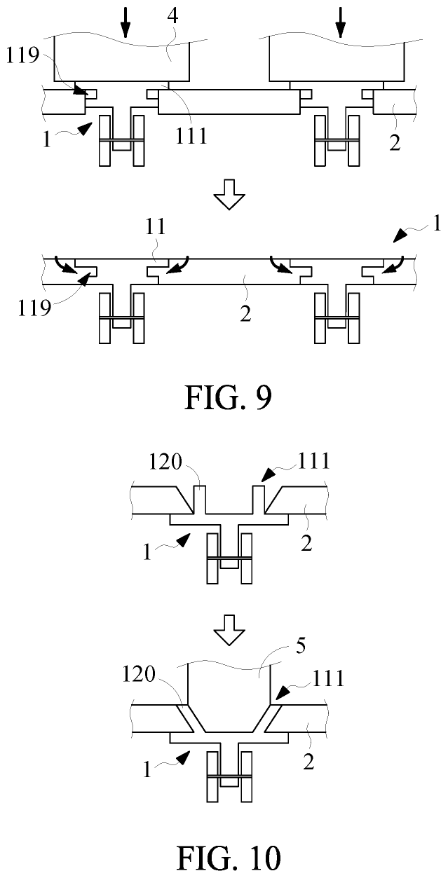

Referring to FIG. 9, in a preferred embodiment of the present disclosure, the first fitting portion 111 has a feeding portion 119, and the first fitting portion 111 is pressed against the object 2 with a die 4, such that a material of the object 2 flows into or enters the feeding portion 119, allowing the first fitting portion 111 to be fitted to the object 2. Therefore, the rolling structure 1 fitted to the object 2 demonstrates enhanced structural strength.

Referring to FIG. 10, in a preferred embodiment of the present disclosure, the first fitting portion 111 has an expandably connecting portion 120, and the expandably connecting portion 120 is pressed under an applied force exerted by a die 5, such that the expandably connecting portion 120 is expandably connected to the object 2, allowing the first fitting portion 111 to be fitted to the object 2, so as to augment the structural strength of the rolling structure 1 fitted to the object 2.

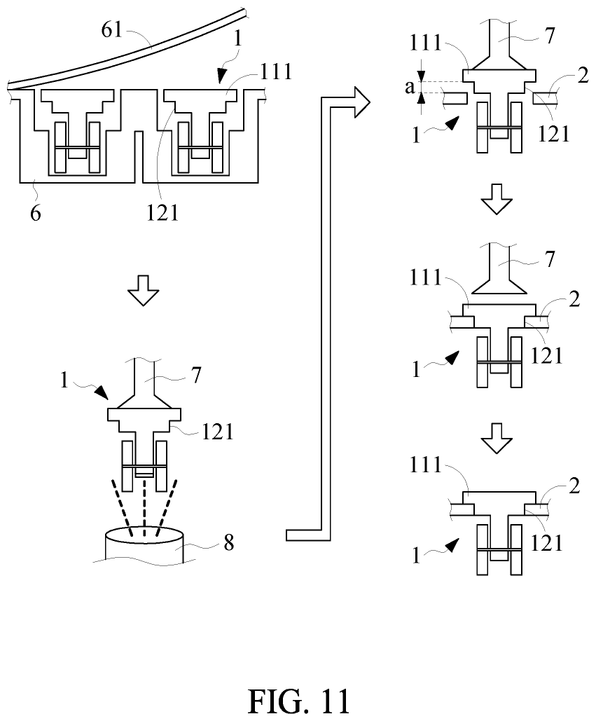

Referring to FIG. 11, in a preferred embodiment of the present disclosure, the first fitting portion 111 has a weldable surface 121, and the rolling structure 1 is placed in a carrying member 6. The carrying member 6 has a cover member 61 for providing a hermetic seal to the rolling structure 1. After picking up the rolling structure 1 with a tool 7, the assembly positions of the rolling structure 1 and the object 2 are compared by a comparison device 8, and the rolling structure 1 is placed on the object 2 with the tool 7 for assembly, wherein the tool 7 uses the information obtained by the comparison device 8 to move the rolling structure 1 to a predetermined height a in the assembly position with the object 2, and then releases or loosens the rolling structure 1 to make the rolling structure 1 drops to the assembly position of the object 2, and during assembly, the weldable surface 121 can be heated and then welded to the object 2. The tool 7 is a vacuum sucker, clamp implement, magnetic tool or engaging implement. The comparison device 8 is a comparison lens with a comparison circuit. Therefore, the first fitting portion 111 can be fitted to the object 2, so as to augment the structural strength of the rolling structure 1 fitted to the object 2.

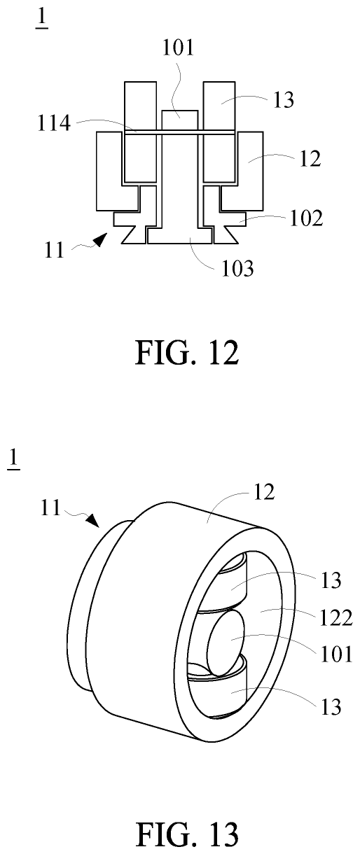

Referring to FIG. 12 and FIG. 13, in a preferred embodiment of the present disclosure, the body portion 11 of the rolling structure 1 is movably fitted to a limiting portion 102 through a body member portion 101. The body member portion 101 has a blocking portion 103. The blocking portion 103 blocks the limiting portion 102 and rotates relative thereto. The second rolling member 13 is disposed at the body member portion 101 and rotates. The first rolling member 12 is confined to between the body portion 11 and the second rolling member 13. Therefore, the first rolling member 12 rolls in the first direction, and the second rolling member 13 rolls in the second direction, thereby allowing the first rolling member 12 and the second rolling member 13 to roll in different directions simultaneously. Therefore, the rolling structure 1 is structurally simple, easy to use, and mechanically strong so as to cut cost.

In a preferred embodiment of the present disclosure, the direction in which the first rolling member 12 rolls and the direction in which the second rolling member 13 rolls are perpendicular to each other.

In a preferred embodiment of the present disclosure, the first rolling member 12 and the second rolling member 13 are in contact with each other while rolling.

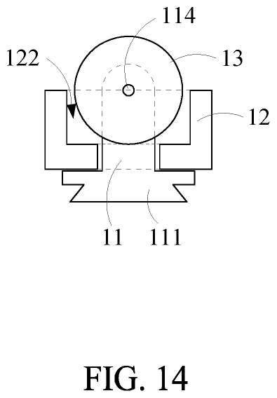

Referring to FIG. 14, in a preferred embodiment of the present disclosure, the first rolling member 12 has a receiving space 121. The receiving space 121 receives part of the second rolling member 13, thereby allowing the present disclosure to meet practical usage needs.

While the present disclosure has been described by means of specific embodiments, numerous modifications and variations could be made thereto by those skilled in the art without departing from the scope and spirit of the present disclosure set forth in the claims.

What is claimed is:

1. A rolling structure comprising:
a body portion disposed at an object;
a first rolling member movably disposed at the body portion and adapted to roll in the first direction; and
at least one second rolling member movably disposed at the body portion and adapted to roll in the second direction.

2. A rolling structure comprising:
a body portion disposed at an object; and
at least one first rolling member movably disposed at the body portion and adapted to roll in the first direction.

3. The rolling structure of claim 1, wherein the body portion has a first fitting portion.

4. The rolling structure of claim 2, wherein the body portion has a first fitting portion.

5. The rolling structure of claim 1, wherein the body portion has a first stopping portion and a second stopping portion between which the first rolling member is disposed.

6. The rolling structure of claim 2, wherein the body portion has a first stopping portion and a second stopping portion between which the first rolling member is disposed.

7. The rolling structure of claim 1, wherein the body portion has a receiving portion for receiving the second rolling member.

8. The rolling structure of claim 1, wherein the second rolling member is connected by a joint portion with the body portion fitting.

9. The rolling structure of claim 1, wherein the body portion has a receiving portion, and an edge of the receiving portion has a blocking portion, allowing the second rolling member to be blocked by the blocking portion and thus disposed in the receiving portion.

10. The rolling structure of claim 1, wherein the second rolling member and rolling members match and roll to thereby reduce rolling friction of the second rolling member, and the rolling members each have a smaller volume than the second rolling member.

11. The rolling structure of claim 1, wherein the body portion has an axle portion, and the first rolling member is fitted to the axle portion.

12. The rolling structure of claim 2, wherein the body portion has an axle portion, and the first rolling member is fitted to the axle portion.

13. The rolling structure of claim 3, wherein the first fitting portion has a receiving portion for receiving the body portion.

14. The rolling structure of claim 4, wherein the first fitting portion has a receiving portion for receiving the body portion.

15. The rolling structure of claim 1, wherein the first rolling member or the second rolling member is connected by a joint portion with the body portion, and the joint portion is a post member, engaging member, bolt member, raised member or dented member.

16. The rolling structure of claim 2, wherein the first rolling member or the second rolling member is connected by a joint portion with the body portion, and the joint portion is a post member, engaging member, bolt member, raised member or dented member.

17. The rolling structure of claim 3, wherein rolling members are disposed between the first fitting portion and the body portion and adapted to reduce friction between the first fitting portion and the body portion.

18. The rolling structure of claim 4, wherein rolling members are disposed between the first fitting portion and the body portion and adapted to reduce friction between the first fitting portion and the body portion.

19. The rolling structure of claim 1, wherein the body portion is movably fitted to a limiting portion through a body member portion, and the second rolling member is disposed at the body member portion and rotates.

20. The rolling structure of claim 1, wherein the body portion is movably fitted to a limiting portion through a body member portion, allowing the second rolling member to be disposed at the body member portion and rotate, and allowing the first rolling member to be confined to between the body portion and the second rolling member.

21. The rolling structure of claim 17, wherein the body member portion has a blocking portion, such that the blocking portion blocks the limiting portion and rotates relative thereto.

22. The rolling structure of claim 18, wherein the body member portion has a blocking portion, such that the blocking portion blocks the limiting portion and rotates relative thereto.

23. The rolling structure of claim 19, wherein the body member portion has a blocking portion, such that the blocking portion blocks the limiting portion and rotates relative thereto.

24. The rolling structure of claim 1, wherein the first rolling member and the second rolling member are in contact with each other while rolling.

25. The rolling structure of claim 1, wherein the first rolling member has a receiving space for receiving part of the second rolling member.

26. The rolling structure of claim 1, wherein the first rolling member is confined to between the body portion and the second rolling member.

27. The rolling structure of claim 3, wherein the first fitting portion has a feeding portion which a material of the object flows into or enters when the first fitting portion is pressed against the object, such that the first fitting portion is fitted to the object.

28. The rolling structure of claim 4, wherein the first fitting portion has a feeding portion which a material of the object flows into or enters when the first fitting portion is pressed against the object, such that the first fitting portion is fitted to the object.

29. The rolling structure of claim 3, wherein the first fitting portion has an expandably connecting portion, and the expandably connecting portion is pressed under an applied force, thereby allowing the expandably connecting portion to be expandably connected to the object.

30. The rolling structure of claim 4, wherein the first fitting portion has an expandably connecting portion, and the expandably connecting portion is pressed under an applied force, thereby allowing the expandably connecting portion to be expandably connected to the object.

31. The rolling structure of claim 1, wherein the rolling structure is used to compare the position of the rolling structure with the object through a comparison device after being picked up by a tool, and the rolling structure is placed on the object with the tool for assembly.

32. The rolling structure of claim 2, wherein the rolling structure is used to compare the position of the rolling structure with the object through a comparison device after being picked up by a tool, and the rolling structure is placed on the object with the tool for assembly.

33. The rolling structure of claim 1, wherein the object is a server, storage, cabinet, casing member, drawer, rail, PCB, motherboard, object, rod member, block member, rack member, carrying member or carried member.

34. The rolling structure of claim 2, wherein the object is a server, storage, cabinet, casing member, drawer, rail, PCB, motherboard, object, rod member, block member, rack member, carrying member or carried member.

35. A method of mounting a rolling structure on an object, the rolling structure having a body portion, a first rolling member and at least one second rolling member, the first rolling member being movably disposed at the body portion and adapted to roll in the first direction, the second rolling member being movably disposed at the body portion and adapted to roll in the second direction, the method comprising the steps of:
providing a tool for taking out the rolling structure;
providing a comparison device for comparing the assembly position of the rolling structure and the object;
using the tool to move the rolling structure to a predetermined height on the assembly position of the object according to the comparison information of the comparison device; and
let the tool release or loosen the rolling structure, so that the rolling structure falls to the assembly position of the object.

36. A method of mounting a rolling structure on an object, the rolling structure having a body portion and at least one first rolling member, the first rolling member being movably disposed at the body portion and adapted to roll in the first direction, the method comprising the steps of:
providing a tool for taking out the rolling structure;
providing a comparison device for comparing the assembly position of the rolling structure and the object;
using the tool to move the rolling structure to a predetermined height on the assembly position of the object according to the comparison information of the comparison device; and
let the tool release or loosen the rolling structure, so that the rolling structure falls to the assembly position of the object.
